(19) United States
(12) Patent Application Publication
(10) Pub. No.: US 2009/0024403 A1
(43) Pub. Date: Jan. 22, 2009

(54) IPTV TRADING SYSTEM AND METHOD

(75) Inventors: Lindsay Scott Servian, Wanchai (CN); Kenneth Che Hin Wong, Tai Hang (CN); Ernest Chun Ming Kwong, Hong Kong SAR (CN)

Correspondence Address: LEYDIG VOIT & MAYER, LTD, 700 THIRTEENTH ST. NW, SUITE 300, WASHINGTON, DC, 20005-3960, US

(73) Assignee: PCCW-HKT DATACOM SERVICES LIMITED, Quarry Bay (CN)

(21) Appl. No.: 11/782,940

(22) Filed: Jul. 25, 2007

(30) Foreign Application Priority Data
Jul. 20, 2007 (HK) 07107911.4

(51) Int. Cl. G06Q 30/00

(52) U.S. Cl. 705/1

(57) ABSTRACT

An electronic commerce system having means for re-formatting data received from an Internet electronic commerce site into a format suitable for display on a target Internet Protocol television.

People are making ever more use of the Internet for shopping, and many business now have web-sites through which their goods and/or services may be purchased by consumers. However computers, particularly personal computers (PCs), are currently the principal means of access to the Internet, but many people do not own a PC or are reluctant to use their PC for shopping.

Many more people own television (TV) sets than own a PC. It is possible to access the Internet using a suitable TV set, and this is known as Internet Protocol Television (IPTV). IPTV is a system is a system where a digital television service is delivered using Internet Protocol over a network infrastructure. A general definition of IPTV is television content that, instead of being delivered through traditional broadcast and cable formats, is received by the viewer through the technologies used for computer networks. It is possible to use IPTV to access most information and services that are available on the Internet, including Internet shopping services (or “e-commerce” services), and this potentially increases the potential market for Internet shopping beyond those people who own a PC.

An IPTV set essentially comprises a TV set and a “set-top box”. In general, a “set-top box” is a component that interfaces between a TV set and a source of television signals other than conventional terrestrial broadcast signals such as, for example, satellite TV signals. In IPTV, a set-top box is a small computer that provides two-way communications on an IPTV network (to allow TV signals to be transmitted to the IPTV set over the IP network, and to allow signals to be returned by the IPTV set to the IP network).

There are however several fundamental limitations imposed by a standard IPTV setup that restricts its usability, such as:
1) Screen size/resolution—although High Definition Television (HDTV) is gaining in popularity, the vast majority of the installed television base has much lower display resolution than the display of a typical PC.
2) Restricted input device—most remote controls for a TV set or IPTV set lack alphanumeric keys and a computer mouse, and this poses significant limitations on the ability of a user to interact with web pages.
3) Limited ability of set-top boxes—underpowered set-top boxes often mean limited browser functionality.
4) Data entry at a subscriber location is often by means of a list of characters, for example a “virtual keyboard”, displayed on the subscriber's television—this entails a lack of privacy for entering confidential data such a password, since anyone within viewing range can see which characters have been entered.

U.S. Pat. No. 6,543,052 proposes an Internet shopping system hosted on a TV set-top box, in which the remote control for the set-top box is provided with a microphone and voice recognition capability, so that a user may enter commands by speaking into the microphone. However, a user who already owns an IPTV set with a conventional remote control is unable to make use of this solution without purchasing new equipment.

A first aspect of the present invention provides an electronic commerce system having: means for re-formatting data received from an Internet electronic commerce site into a format suitable for display on an Internet Protocol television set. Following the reformatting the data may be transmitted to a target IPTV for display—the re-formatting addresses the problem that the display of a typical IPTV has a lower resolution and/or screen size than the display of a typical PC, and allows the user to see a good quality image.

Other aspects and features of the present invention are set out in the remaining claims.

Preferred embodiments of the present invention will now be described by way of illustrative example with reference to the accompanying Figures in which:

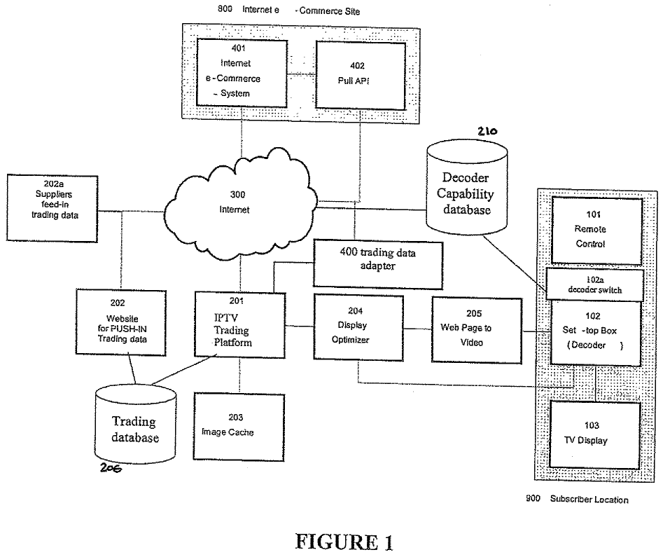

FIG. 1 is a schematic block view of an IPTV e-commerce system according to the present invention;

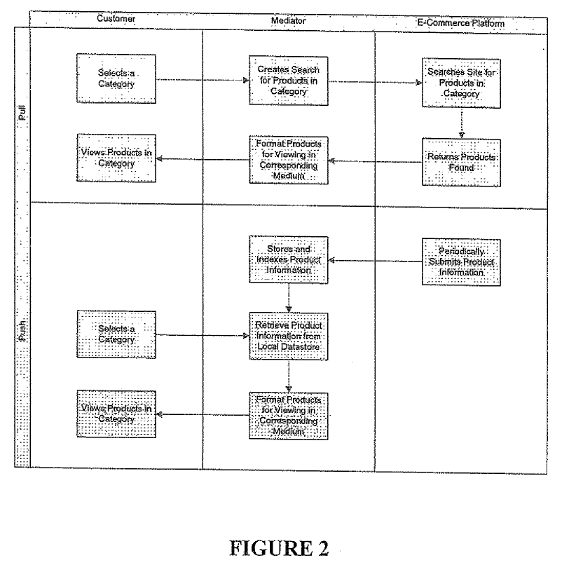

FIG. 2 is a schematic flow diagram illustrating operation of the e-commerce system of FIG. 1;

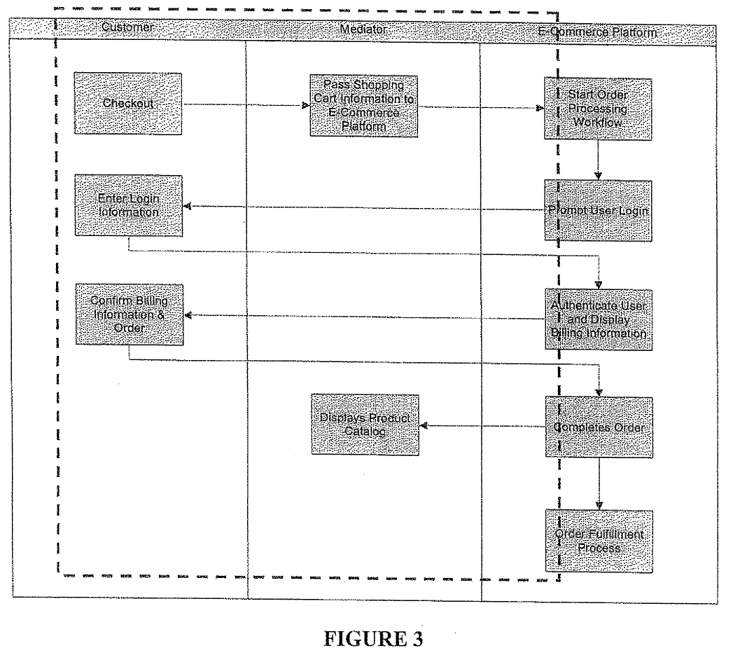

FIG. 3 is a schematic flow diagram illustrating operation of the e-commerce system of FIG. 1;

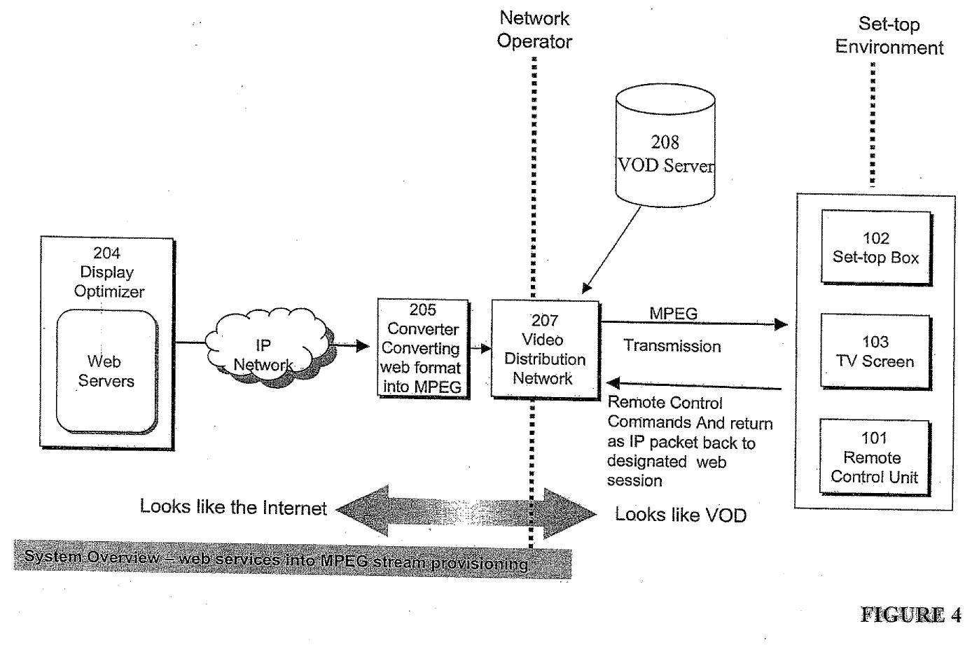

FIG. 4 is a schematic block diagram of a system for converting a web browser session to a video signal;

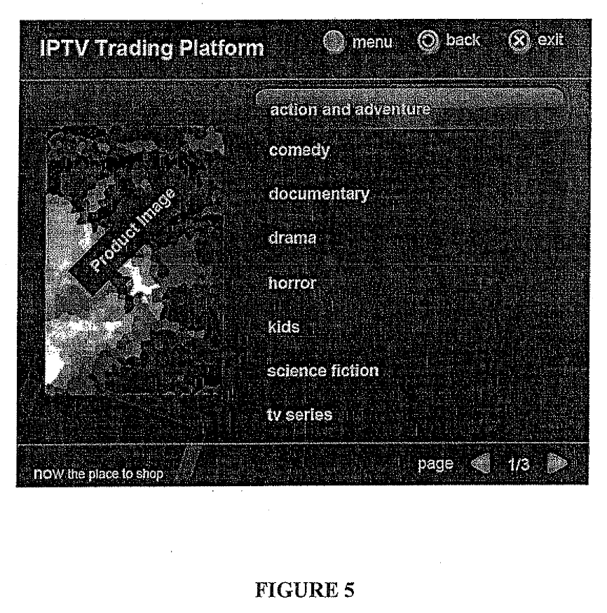

FIG. 5 is an illustration of a shopping page as displayed by the e-commerce system of the present invention; and

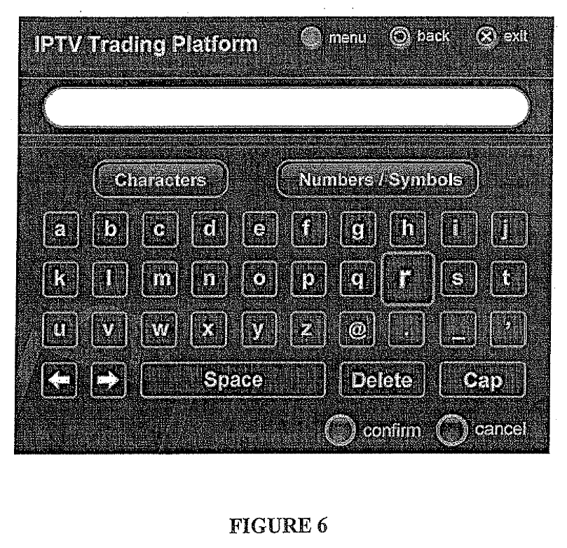

FIG. 6 is an illustration of a virtual keyboard as displayed by the e-commerce system of the present invention

FIG. 1 is a block schematic diagram of an e-commerce system of the present invention. The e-commerce system comprises an IPTV trading platform, denoted as block 201. The objective of the IPTV e-commerce system is to aggregate and adapt the content from one or more Internet e-commerce sites (only one Internet e-commerce site 800 is shown in FIG. 1, but in practice there would be many such sites), for use on an IPTV owned by a subscriber to an IPTV service. The IPTV equipment at the subscriber location 900 comprises a TV display 103 which is controlled by a set-top box (or decoder) 102 having a decoder switch 102a. A subscriber can control the set-top box using a remote control unit 101.

The e-commerce trading platform 201 aggregates content from existing Internet e-commerce sites 800, and this may be managed under standardised e-commerce logic. Product-related information may be input to the e-commerce trading platform 201 by one of the following methods:
1) A “push” method, in which product information is uploaded to the IPTV trading platform 201 from suppliers, via a data input website 202.
2) A “pull” method, in which product information is retrieved (“pulled”) from an internet e-commerce system 401 at an internet e-commerce site 800, via a standard set of application programming interfaces (APIs) 402 as required, for example in response to a customer enquiry. Pulling product information from an internet e-commerce system provides the most up-to-date product information possible.

FIG. 2 illustrates the principal steps of the “pull” and “push” methods of inputting product-related information to the IPTV e-commerce system 201. In the “pull” method, a customer initially selects a desired category of goods that they wish to browse through for possible purchase, such as for example books, clothing etc. The customer selects the category via their TV display 103 and the remote control unit 101, as we describe below, and this information is passed from the set-top box 102 at the customer location to the IPTV e-commerce trading platform 201. The trading platform 201 then creates a search for products in this category, for example by retrieving details of suitable internet e-commerce sites 800 from a trading database that lists known internet e-commerce sites and the categories of products/services that they provide. The trading database is shown as 206 in FIG. 1.

Once a suitable e-commerce site 800 has been located, the IPTV e-commerce platform 201 sends an enquiry to the selected e-commerce site 800, for example via the internet 300 or any other suitable communication networks. The e-commerce site then searches its site for products in the desired category, and returns details of products found to the IPTV e-commerce trading platform 201. The IPTV e-commerce system of the invention then formats the returned product information to make it suitable for viewing by the subscriber over their TV display 103, as is described in more detail below, and transmits the information to the subscriber location 900 for display on the TV display 103. The subscriber is then able to view the supplied product information.

The IPTV e-commerce platform 201 thus acts as a “mediator” between the customer and the Internet e-commerce site 800.

It can be seen, therefore, that in the “pull” method information is retrieved from an e-commerce site 800 in response to a specific query from a potential customer. In contrast, in the “push” method, a supplier 202a submits product information to the e-commerce trading platform 201, for example at periodic intervals. This is done via a website 202. The IPTV e-commerce system 201 stores the supplied product information, in a preferred embodiment in the trading database 206, and preferably also indexes the stored product information to allow for easy retrieval.

When a subscriber sends a request for information about products in a particular category, the e-commerce trading platform 201 then retrieves product information from the trading database 206, formats the information for viewing on the subscriber's IPTV, and forwards the information to the subscriber location as described above. The subscriber is then again able to view the supplied product information.

FIG. 3 illustrates steps in the subscriber purchasing one or more products or services offered by an Internet e-commerce site 800 via the IPTV e-commerce trading platform 201. Initially, the subscriber selects one or more products/services from the information displayed on their TV display 103, until they have selected all desired products/services that they wish to purchase. This may be done, for example, by the customer selecting items to be placed in a “virtual shopping basket” or “shopping cart” in a known manner. When this process is complete, the customer checks out of the selection process, and information about the selected products/services is passed to the e-commerce trading platform 201 and on to the Internet e-commerce site 800. The Internet e-commerce site 800 processes the order, and will generally ask the user to enter a login to enable their identity to be verified. The login information entered by the user is verified by the Internet e-commerce site 800 and, if the user is authenticated, billing information is sent to the customer location for display. The customer is then required to confirm the order and enter payment details, for example credit card details. Once the customer has done this, the Internet e-commerce site 800 completes the order, and arranges for the selected products/services to be supplied to the customer.

Once the order has been completed, the Internet e-commerce site 800 may send its current product catalogue to the IPTV e-commerce system.

The IPTV e-commerce system of the present invention is able to provide content adaptation, which adapts the content of information returned by the c-commerce site 800 or retrieved from the trading database 206, to make it suitable for display on the customer's TV display 103. The content adaptation may include one or more of the following features:
1) Display Optimisation
   a: adjustment of the size and/or aspect ratio of a displayed page of shopping information, and/or adjusting fonts and images to take account of the characteristics of the customer's TV display 103 such as screen resolution, screen size and aspect ratio; and
   b: keyword-sensitive image caching and pre-processing.
2) Navigation Adaptation
   a: browser key mapping to the keys of the IPTV remote control unit 101; and
   b: alphanumeric keyboard emulation—standard or secure input.
3) Browser Meditation
4) Autoconfiguration Switching

The IPTV e-commerce system of the present invention is provided with a display optimiser 204 for performing the content adaptation.

The various adaptation features outlined above will now be described in more detail.

### Display Optimisation

As explained above, there are many differences between a typical TV display and a typical PC display screen; in particular the screen resolution of a TV display is generally significantly lower than the screen resolution of a typical PC display. As result of these differences, the information supplied by an Internet e-commerce site 800 requires to be re-formatted in order to provide a satisfactory display on the display 103 of a typical IPTV system at a subscriber location 900. Information supplied by an e-commerce site 800 will typically be in the form of one or more “data pages”, where a “data page” is an information page displayed by a web browser such that a user may read it by scrolling down. Data pages supplied by different Internet e-commerce sites will in general be of different sizes from one another, and be configured differently from one another. The display optimiser 204 is therefore arranged to re-format the received pages—whether they are received direct from the e-commerce site 800 in the “pull” mode or whether they are retrieved from the trading database 206 after having been supplied by a supplier using the “push” mode. The re-formatting may involve changing the screen layout of a particular page, but may also involve more than this—the lower resolution of a typical TV display screen means that less information can be displayed per page, so that reformatting the data from the e-commerce site 800 is likely to involve an increase in the page count (where the “page count” is the number of pages required to display all the provided information). Preferably, a data page from an e-commerce site is likely to be broken down into two or more pages by the display optimiser such that, when the re-formatted pages are transmitted to a user, the entire display content of a selected re-formatted page will be visible to a user when the page is displayed on their TV display screen 103. The adaptation of the format of the data to suit the format of the TV display screen 103 therefore will generally represent the most significant portion of the required re-design and development effort.

To minimise the development effort required for the adaptation of web trading sites, a common user interface is preferably used to display the product catalogues of all internet e-commerce sites 800. This user interface is customised for use with IPTV, and encompasses all the necessary functions for catalogue viewing and shopping cart maintenance. The term “user interface” refers to the format of the output from the IPTV e-commerce system as displayed on the display 103 of a subscriber's television, and also to the mechanism for a user to enter data (which, as explained below, is via the remote control unit 101.

### Layout/Size Adjustment

Most Internet websites are designed to be viewed on PC screens having resolutions of around 1024×768 (XGA). As explained above, the data pages supplied by the e-commerce site 800 (whether supplied by the “pull” method in response to a specific request or supplied by the “push” method) require adaptation for viewing on a IPTV display screen having a lower resolution. The precise adaptations that are required will depend on the particular TV standard supported by the display screen 103. For the PAL/NTSC TV standards, since the resolution is much lower than for a typical PC screen, the page layout needs to be changed to include less information per page. The size of images, and the font size of text used, also need to be increased to ensure good legibility when the pages are displayed on the low resolution TV display.

To provide for adaptation of a data page supplied by an e-commerce site 800 for display on a TV display, there are generally three areas to be adjusted:
1) Viewing Area
A typical TV screen may be smaller than, and may have a different aspect ratio than, a typical PC display screen. To account for this, the standard PC screen page is trimmed down, so that the displayed image covers a “safe area”, which is an area estimated to be visible on all typical TV sets. The safe area may be set as, for example, safe area=640×523 pixels (giving an aspect ratio of 4:3).

The design alignment of the reformatted page preferably starts from the upper left corner of the page. This is to avoid placing the content active elements on an edge of the safe area.
2) Colours on TV
High intensities of red, green and blue, and saturated colours (including red and yellow), of a data page supplied by an e-commerce site 800 are preferably replaced with a preset colour by the display optimiser 204, to improve legibility of information displayed on a TV display screen 103. If a website contains pure white fonts on a dark background, these are preferably also replaced with a dark font on a light background.
3) Text
It is preferable to ensure that a minimum font size is used in the re-formatted pages supplied to the IPTV at the subscriber location. The display optimiser 204 therefore preferably applies a minimum font size to the re-formatted pages. For example, a display optimiser 204 may apply a minimum font size of 20 points for Chinese characters, and a minimum font size of 18 points for English characters.

Furthermore, Sans Serif fonts (eg Arial, Comic Sans MS, Tahoma and Verdana) may provide clearer display than a Serif font. The display optimiser 204 therefore preferably ensures that only Sans Serif fonts are used in the re-formatted pages.

In a preferred embodiment, the product information is displayed on the television display 103 of a user using a standard template, designed specifically to suit a television display, regardless of the original design and layout of the data pages supplied by the Internet e-commerce site 800.

### Keyword Sensitive Caching

One often overlooked difference between the “TV experience” compared to that of a PC-based web surfing is that of user expectation. TV viewing is mainly still a broadcast experience, so that latency between a user action and the system response is relatively short. This is not, however, the case for a PC-based web surfing session. Whereas changing the channel displayed on a TV set will usually take no more than two seconds, it is not unusual for a web page to take ten seconds or more to load.

Thus, if an e-commerce system search were to take around five seconds, a PC user might consider this to be fast, but a TV user might well consider it to be slow.

In order to reduce the time taken to respond to a user request, the IPTV e-commerce system preferably caches some data, for example in the image cache 203. While a significant portion of the data from the source e-commerce sites 800 must be retrieved in real time (for example price and availability information), some data are more static and thus may be cached in the IPTV e-commerce system. By storing, for example, images of products and other sizeable data items related to the most frequently used search terms, the overall response time of the system may be improved. The IPTV e-commerce system thus preferably stores images and other information in the image cache 203. The stored information may be selected according to, for example, a list of “hot keywords”, namely the keywords which are used most frequently by users when requesting product information. The list of “hot keywords” may be obtained from the source internet e-commerce sites 800, and/or may be obtained from a general list of internet “hot keywords”.

The images and other data stored in the image cache 203 may be stored in the form in which they are supplied by a source e-commerce site. In this case, when cached information is retrieved from the image cache 203 in response to a user request, the retrieved images/data must be re-formatted by the display optimiser 204 according to one or more of the methods described above, before supply to the subscriber location.

As an alternative, the data from the source internet e-commerce sites may be re-sized before it is cached, so that the image cache stores the re-sized data. When a user request is received, the re-sized data can then be immediately retrieved from the image cache and sent to the subscriber (assuming that the re-formatted data stored in the image cache has been re-formatted correctly for the IPTV at the subscriber location.

### Navigation Adaptation

Another significant difference between PC and TV usage lies in the different user behaviour and standard input devices.

A PC user will normally have their body leaning forwards slightly (head forward), with the keyboard and screen of the PC within the field of vision. The distance between the eye and the keyboard is therefore similar to the distance between the eye and the screen, so that looking backwards and forwards between the screen and the keyboard is not tiring on the user's eyes.

A TV user, on the other hand, normally has their body leaning backwards slightly (head back), with only the TV screen within view. Use of the remote control unit is mostly by feel, since looking from the TV screen to the remote control unit requires the user to re-focus their eyes since the remote control unit is normally much closer than the TV screen. The exception is seldom-used functions on the remote control unit, in which case the user is required to take his/her eyes off the TV screen and look down onto the remote control unit.

These differences, together with the fact that a TV user will not normally have a full alphabet keyboard or a computer mouse available, means that adaptation of the method in which a user navigates through a displayed screen, and the method by which a user enters data such as selecting a product, is required in order to adapt a web trading platform for use over IPTV.

According to the present invention, therefore, navigation through the product catalogue, as displayed on the subscriber's IPTV screen 103 is preferably arranged so as to be possible using primarily the “arrow” and “enter” keys of the remote control unit 101. This facilitates the user navigating by touch only, without the need for the user to take their eyes off the screen and look at the remote control unit. Furthermore, by using only the “arrow” and “enter” keys, key mapping of different remote control units to allow navigation through a standard keyboard is facilitated. The mapping of the keys of the remote control unit onto desired functions is performed by the set-top box 102

In one embodiment, a virtual keyboard having a conventional layout of alphanumeric keys may be used. One suitable virtual keyboard is shown in FIG. 6.

A user may navigate through the virtual keyboard of FIG. 6 by using the “arrow” keys to move up, down, left or right, and by using the “enter” key to select a particular key.

The virtual keyboard of FIG. 6 may, for example, be displayed on a portion of the user's TV screen 103, with product information being displayed on the remaining part of the screen. Alternatively, a user may be able to initiate and terminate display of the virtual keyboard using the remote control unit 101, for example by selecting a “display keyboard” or “close keyboard” icon displayed on the screen 103.

The virtual keyboard may be adapted to show the key that is currently selected in a different manner to the other keys, for example by increasing the size of the selected key. This is shown in FIG. 6, in which the “R” key, which the currently selected key, is shown larger than the other alphabet keys.

While use of the virtual keyboard of FIG. 6 can provide a convenient and straightforward method for a user to enter information and commands, it has the potential disadvantage that any other people within view of the screen will be able to determine which characters have been selected by the user. In a case where a user wishes to enter private information (such as a password), a more secure version of a virtual keyboard is required. One possible way of achieving this is to select a particular alphanumeric character using one or more buttons of the remote control unit, such that an inputted character is not revealed to a third party. For example, one possible way of entering the full alphabet that uses the numeric buttons and colour buttons of the remote control unit is shown in Table 1.

TABLE 1

| | 0 | 1 | 2 | 3 | 4 | 5 | 6 | 7 | 8 | 9 |
|---|---|---|---|---|---|---|---|---|---|---|
| [symbol] | A | B | C | D | E | F | G | H | I | J |
| [symbol] | K | L | M | N | O | P | Q | R | S | T |
| [symbol] | U | V | W | X | Y | Z | @ | . | _{—} | ‘ |

In the key mapping scheme of Table 1, each alphanumeric character is associated with (or mapped to) a respective permutation of the one or more keys of the remote control unit 101 of the subscriber's television. The user selects a number between 0 and 9 by pressing the appropriate number key on the remote control unit. To select other characters, the user pressing a colour key of the remote control unit followed by a number key of the remote control unit, and the corresponding letter given by Table 1 is then selected. The television at the user location is preferably arranged such that the inputted character is not displayed on the screen, so that the inputted character is not revealed to a third party.

In this embodiment, the association/mapping between the keys of the remote control unit 101 and the desired alphanumeric characters (eg the letters of the alphabet, the numbers 0 to 9, and any other desired characters) is made by the set-top box 102, which then instructs the display 103 to of the subscriber's television to display the association, for example in the tabular form shown in Table 1 (although the association could be displayed in any suitable way).

When the set-box detects activation/depression of one or more keys of the remote control unit, it determines which key(s) was/were activated/depressed, and determines the entered alphanumeric character from the association/mapping between the keys of the remote control unit 101 and the alphanumeric characters.

In this embodiment, the mapping between the keys of the remote control unit and the alphanumeric characters may be dynamic, in that the set-top box 102 may change the mapping. For example, the mapping may be changed after a pre-set time, a new mapping may be used each time that secure data entry is required, or it may be changed after each character is entered. Alternatively, the mapping may be static, in that the mapping is not changed.

The secure data entry method has the following advantages:
1) The method allows a user to enter alphanumeric data via the keys of a standard remote control.
2) There is no feedback on-screen as to which key was selected or entered.
3) The method is relatively easy to use—no instruction manual is required, since the mapping is displayed to the user on the screen.

The method is not limited to the mapping shown in Table 1, and any suitable mapping may be used. Another possible mapping is shown in Table 2:

TABLE 2

| | 0 | 1 | 2 | 3 | 4 | 5 | 6 | 7 | 8 | 9 |
|---|---|---|---|---|---|---|---|---|---|---|
| [symbol] | 0 | 1 | 2 | 3 | 4 | 5 | 6 | 7 | 8 | 9 |
| [symbol] | A | B | C | D | E | F | G | H | I | J |
| [symbol] | K | L | M | N | O | P | Q | R | S | T |
| | U | V | W | X | Y | Z | @ | . | _{—} | ‘ |

To enter a character, the user will have to press a colour key followed by a numeric key. For example:

| A | Green + 0 |
|---|---|
| B | Green + 1 |
| Z | Yellow + 5 |
| 9 | Red + 9 |

This method can be adapted in many ways to suit different needs, for example:

1. The mapping of Table 2 may be changed to allow numeric characters to be entered directly (without preceding colour button), and use the Red button combinations for entering other punctuation marks.

2. If required, the number of characters that can be entered may be increased by using 2 numeric buttons to follow a colour button press (e.g. Red+8+0 for [symbol] ).

The secure data entry of the method is not limited to the IPTV shopping method of the invention, but may be used in other applications where secure data entry of confidential information such as, for example, passwords, credit card details or price information is required.

### Browser Mediation

The set-top box 102 of the IPTV system at the user location 900 contains a web browser, but in many set-top boxes the web browser is very light so that its performance may be very slow. Furthermore, some usual web-related technologies (for example, FLASH) may not be supported.

In a preferred embodiment of the present invention, therefore, the IPTV e-commerce system contains a converter 205 for converting a page to a video stream. The converter 205 receives one or more re-formatted pages from the display optimiser 204, and converts them to a video stream for transmission to the set-top box 102 at the subscriber location 900.

In the case of a set-top box having a good specification web browser, it may not be necessary to convert re-formatted web pages to video. In this case, the display optimiser 204 may send re-formatted web pages direct to the set-top box 102, as indicated by the broken line running from the display optimiser 204 to the set-top box 102 in FIG. 1, thus by-passing the converter 205.

Commercially available packages for converting web pages to video are known, and any suitable such package may be used for the converter 205.

FIG. 4 illustrates a system for converting a web-browser session to/from a video signal, suitable for use in an embodiment of the present invention in which the converter 205 is provided. The output from the converter 205 may be supplied to the IPTV at the subscriber location 900 over any suitable active video distribution network 207 that is used for supplying video to the user from, for example, a video-on-demand (VOD) server 208. The video is supplied over an existing VOD infrastructure, for example as MPEG files. Commands entered by the user using the remote control unit 101 are sent to the distribution network 207 via the existing VOD infrastructure. Thus, the IPTV shopping experience presented to the user resembles a conventional video-on-demand session.

The part of FIG. 4 to the left of the converter (205) is a normal web browser session. In an implementation of the invention, the output of the “Display Optimizer 204” is converted to video by the converter 205, and is passed to the video distribution network 207 for onwards transmission to a user.

### Auto-Configuration Switching

TV displays are not of a standard size, aspect ratio or screen resolution.

In a preferred embodiment, therefore, the IPTV e-commerce system of the present invention is able to determine information about a target TV display 103, to which pages are to be sent. The display optimiser may then use the knowledge of the target TV display 103 in reformatting the pages. For example, if the aspect ratio of the target TV display is known, the display optimiser may re-format the pages to that aspect ratio before they are transmitted to the subscriber location.

Information about the target IPTV system may be obtained by detecting the model of the IPTV set-top box 102, and retrieving information about that model of decoder from a decoder capability database 210.

Knowledge about the set-top box at the target IPTV system may also be used to determine whether a conversion to video is required, and direct the output of the display optimiser either to the converter 205 or direct to the set-top box of the target IPTV system accordingly.

FIG. 5 is a schematic illustration showing a page as displayed on the TV display 103 of the target IPTV system. Since the number of categories and sub-categories of products available may well be numerous, they are shown in FIG. 5 as presented as a simple list. Furthermore, the list is shown in FIG. 5 as covering three pages, and a user is able to move from one page to another using the “left arrow” button and “right arrow” button of the remote control unit 101.

A user may also navigate through the categories displayed on a page, for example using the “up arrow” and “down arrow” buttons on the remote control unit 101. In FIG. 5, the selected category is highlighted, and a sample of books under the highlighted category is displayed at the left of the screen.

1. An electronic commerce system comprising means for re-formatting data received from an Internet electronic commerce site into a format suitable for display on a target Internet Protocol television.

2. A system as claimed in claim 1, wherein the data received from the Internet electronic commerce site comprise one or more data pages having a first format.

3. A system as claimed in 2, wherein the system reformats the received data pages into one or more output data pages having a second format different from the first format.

4. A system as claimed in claim 3, including a video converter for converting output data pages to a video stream.

5. A system as claimed in claim 1, including determining means for determining a suitable format for data to be transmitted to the target IP television.

6. A system as claimed in claim 5, wherein the determining means are adapted to determine a characteristic of a set-top box associated with the target IP television.

7. A system as claimed in claim 6, wherein the determining means retrieve, in use, a suitable format for data to be transmitted to the target IP television from a first database.

8. A system as claimed in claim 1, including a second database for storing data received from the Internet electronic commerce site.

9. A system as claimed in claim 8, wherein the second database stores, in use, re-formatted data.

10. A system as claimed in claim 1, being adapted to retrieve data from the Internet electronic commerce site in response to a user request.

11. A system as claimed in claim 1, being adapted to retrieve data from the second database in response to a user request.

12. A system as claimed in claim 2, being adapted to reformat a data page received from the Internet electronic commerce site by changing its size.

13. A system as claimed in claim 2, being adapted to reformat a data page received from the Internet electronic commerce site by changing its aspect ratio.

14. A system as claimed in claim 2, being adapted to reformat data pages received from the Internet electronic commerce site by changing their page layout.

15. A system as claimed in claim 2, being adapted to reformat a data page received from the Internet electronic commerce site by increasing a font size.

16. A system as claimed in claim 2, being adapted to reformat a data page received from the Internet electronic commerce site by changing a font type.

17. An electronic commerce system comprising a video converter for converting output data pages to a video stream for transmission to an Internet Protocol television.

18. An electronic commerce method comprising re-formatting data received from an Internet electronic commerce site into a format suitable for display on a target Internet Protocol television.

19. A method as claimed in claim 18, including transmitting the re-formatted data to the target Internet Protocol television.

20. A method as claimed in claim 18, including the step of receiving the data from the Internet electronic commerce site as one or more data pages having a first format.

21. A method as claimed in claim 20, including the step of reformatting the received data page(s) into one or more output data pages having a second format different from the first format.

22. A method as claimed in claim 21, further including the step of converting output data pages to a video stream.

23. A method as claimed in claim 18, including determining a suitable format for data to be transmitted to the target IP television.

24. A method as claimed in claim 23, wherein the step of determining the suitable format comprises determining a characteristic of a set-top box associated with the target IP television.

25. A method as claimed in claim 24, wherein the step of determining the suitable format further comprises retrieving, from a first database, a suitable format for data to be transmitted to the target IP television.

26. A method as claimed in claim 18, including storing data received from the Internet electronic commerce site in a second database.

27. A method as claimed in claim 26, further including storing reformatted data in the second database.

28. A method as claimed in claim 18, including the step of retrieving data from the Internet electronic commerce site in response to a user request.

29. A method as claimed in claim 18, including the step of retrieving data from the second database in response to a user request.

30. A method as claimed in claim 19, further including the step of reformatting a data page received from the Internet electronic commerce site by changing its size.

31. A method as claimed in claim 19, further including the step of reformatting a data page received from the Internet electronic commerce site by changing its aspect ratio.

32. A method as claimed in claim 19, further including the step of reformatting data pages received from the Internet electronic commerce site by changing their page layout.

33. A method as claimed in claim 19, further including the step of reformatting a data page received from the Internet electronic commerce site by increasing a font size.

34. A method as claimed in claim 19, further including the step of reformatting a data page received from the Internet electronic commerce site by changing a font type.

35. A method as claimed in claim 18, including the further steps of: displaying a virtual keyboard on the target IP television; and entering a user request using the virtual keyboard.

36. A method as claimed in claim 35, further including selecting one or more virtual keys of the virtual keyboard using a remote control unit of the target IP television.

37. A method as claimed in claim 18, including the further steps of: mapping one or more alphanumeric characters to keys of a remote control unit of the target IP television; and entering a user request using the remote control unit.

38. An electronic commerce method comprising the step of converting output data pages to a video stream for transmission to an Internet Protocol television.

39. A method of providing encoded data entry, comprising the steps of:
a) associating one or more alphanumeric characters with a respective permutation of one or more keys of a control unit;
b) displaying the association of the one or more alphanumeric characters with the respective permutations to a user;
c) determining the entry of a permutation of one or more keys of the control unit; and
d) determining the alphanumeric character associated with the entered permutation.

40. A method as claimed in claim 39, wherein step (b) comprises displaying the association on the display of a television, and the control unit is a control unit of the television.

41. A method as claimed in claim 40, wherein step (a) is performed in a controller of the television.

42. A method as claimed in claim 41, wherein step (a) is performed in a set-top box of the television.

43. An apparatus for providing encoded data entry, comprising:
a) means for associating one or more alphanumeric characters with a respective permutation of one or more keys of a control unit;
b) a display for displaying the association of the one or more alphanumeric characters with the respective permutations to a user;
c) means determining the entry of a permutation of one or more keys of the control unit; and
d) means for determining the alphanumeric character associated with the entered permutation.
